(19) United States
(12) Patent Application Publication
(10) Pub. No.: US 2023/0031324 A1
(43) Pub. Date: Feb. 2, 2023

(54) CONSUMABLE MATERIAL MAP GENERATION SYSTEM

(71) Applicant: TIGER CORPORATION, Osaka (JP)

(72) Inventors: TOMOMI INOUE, Osaka (JP); YUJI MESHIZUKA, Osaka (JP); YUTA MAEDA, Osaka (JP)

(73) Assignee: TIGER CORPORATION, Osaka (JP)

(21) Appl. No.: 17/853,860

(22) Filed: Jun. 29, 2022

(30) Foreign Application Priority Data
Jul. 27, 2021 (JP) 2021-122324

(51) Int. Cl. G06Q 30/06

(52) U.S. Cl. CPC G06Q 30/0631

(57) ABSTRACT

A consumable material map generation system according to the invention includes: a storage part 120, associating at least one characteristic information with respect to type information of consumable materials and storing the characteristic information; an information display part 130, displaying information; and an information processing part 110, generating a consumable material map by mapping the type information one or more dimensionally based on the characteristic information to display the consumable material map on the information display part.

### CROSS-REFERENCE TO RELATED APPLICATION

This application claims the priority benefit of Japan application serial no. 2021-122324 filed on Jul. 27, 2021. The entirety of the above-mentioned patent application is hereby incorporated by reference herein and made a part of this specification.

### BACKGROUND

### Technical Field

The invention relates to a consumable material map generation system.

### Description of Related Art

Generally, there are various brands and types of consumable materials (e.g., rice, miso, tofu, etc.). When selecting the brand or type, most people rely on the reputation, words of mouth, etc., of such brand or type, and eventually people have to repeat try-and-error for many times to find their favorite consumable materials (the inventors of the invention are not aware of any method for finding one's own favorite consumable material except for the above).

However, repeating try-and-error for many times is time and cost consuming, making it rather unrealistic. Therefore, it is expected to develop a process capable of efficiently finding a favorite consumable material.

### SUMMARY

A consumable material map generation system according to the invention includes: a storage part, associating at least one characteristic information with respect to type information of consumable materials and storing the characteristic information; an information display part, displaying information; and an information processing part, generating a consumable material map by mapping the type information one or more dimensionally based on the characteristic information to display the consumable material map on the information display part.

### BRIEF DESCRIPTION OF THE DRAWINGS

FIG. 1 is a view illustrating an overall configuration of a consumable material map generation system according to an embodiment of the invention.

FIG. 2 is a block diagram illustrating a configuration of a server and a consumer terminal according to an embodiment of the invention.

FIG. 3 is a view illustrating a table for the consumable material map according to an embodiment of the invention.

FIG. 4 is a view illustrating a consumable material map information according to an embodiment of the invention.

FIG. 5 is a view illustrating consumable material map information according to an embodiment of the invention. In the figure, a portion of type information of consumable materials that is mapped is displayed with emphasis.

FIG. 6 is a view illustrating a consumable material association information table according to an embodiment of the invention.

FIG. 7 is a view illustrating a screen transition when narrowing down consumable materials at the consumer terminal according to an embodiment of the invention.

FIG. 8 is a view illustrating a screen transition when displaying information associated with type information on the consumer terminal according to an embodiment of the invention.

FIG. 9 is a view illustrating a screen transition when selecting the type information displayed on the consumer terminal according to an embodiment of the invention.

(a) to (c) of FIG. 10 are views illustrating a screen transition when displaying a route from reference type information to target type information via type information other than the reference type information and the target type information according to an embodiment of the invention. In the views, the type information from the reference type information to the target type information is completely displayed in series for each route.

(a) to (d) of FIG. 11 are views illustrating a screen transition when displaying a route from the reference type information to the target type information via the type information other than the reference type information and the target type information according to an embodiment of the invention. In the views, only the next type information from the reference type information to the target type information is displayed for each route.

FIG. 12 is a view illustrating a route derivation method in a case where the reference type information and the target type information are set in the consumable material map information according to an embodiment of the invention.

### DESCRIPTION OF THE EMBODIMENTS

An aspect of the invention provides a computer system capable of efficiently finding a favorite type of consumable materials.

A consumable material map generation system according to the invention includes: a storage part, associating at least one characteristic information with respect to type information of consumable materials and storing the characteristic information; an information display part, displaying information; and an information processing part, generating a consumable material map by mapping the type information one or more dimensionally based on the characteristic information to display the consumable material map on the information display part.

According to the configuration, for example, in the case where the consumable materials are rice and the type information is rice brands, by plotting the characteristic information of multiple types of the brands (for example, the index value of the softness of the rice or the index value of the stickiness of the rice at the time of cooking) for each brand with multi-dimensional coordinates, a multi-dimensional consumable material map can be generated, and the consumable material map can be displayed on the information display part. Therefore, in the consumable material map generation system, a favorite type of consumable materials can be found efficiently.

In the consumable material map generation system according to the invention, the information processing part may be capable of displaying, with emphasis, at least one type information selected among the mapped type information on the consumable material map.

According to the configuration, the type information that is selected and the type information that is not selected can be clearly distinguished, and, as a result, the user of the consumable material map generation system finds the selected type information with ease.

In the consumable material map generation system according to the invention, the consumable material map generation system has a first setting function in which one type information among the type information is set as reference type information and a second setting function in which one type information among the type information is set as target type information. In a case where the reference type information is set by the first setting function and the target type information is set by the second setting function, the information processing part may connect, by using a line, the type information so that a distance of a passage from the reference type information to the target type information through the type information other than the reference type information and the target type information is shortest and display the type information on the information display part.

According to the configuration, the type information can be displayed in a form of gradually approaching the target type information (e.g., “Yumepirika” whose “softness” and “stickiness” are desirable to the consumer) from the reference type information (e.g., “Akitakomachi” which is the rice which the consumer is now having).

Therefore, in the consumable material map generation system, the user can enjoy and search for various types of consumable materials by targeting at the type of consumable materials having the favorite characteristic.

In the consumable material map generation system according to the invention, the type information may include information of a mixed consumable material obtained by mixing at least two types of consumable materials, and the characteristic information may include mixed characteristic information determined based on the characteristic information corresponding to the type information of the consumable materials forming the mixed consumable material and information of a mix ratio of the consumable materials.

According to the configuration, the mixed characteristic information of the mixed consumable material can be obtained. Therefore, in the consumable material map generation system, the fun and the value of mixing various types of consumable materials can be provided.

### <Configuration of Consumable Material Map Generation System According to an Embodiment of the Invention>

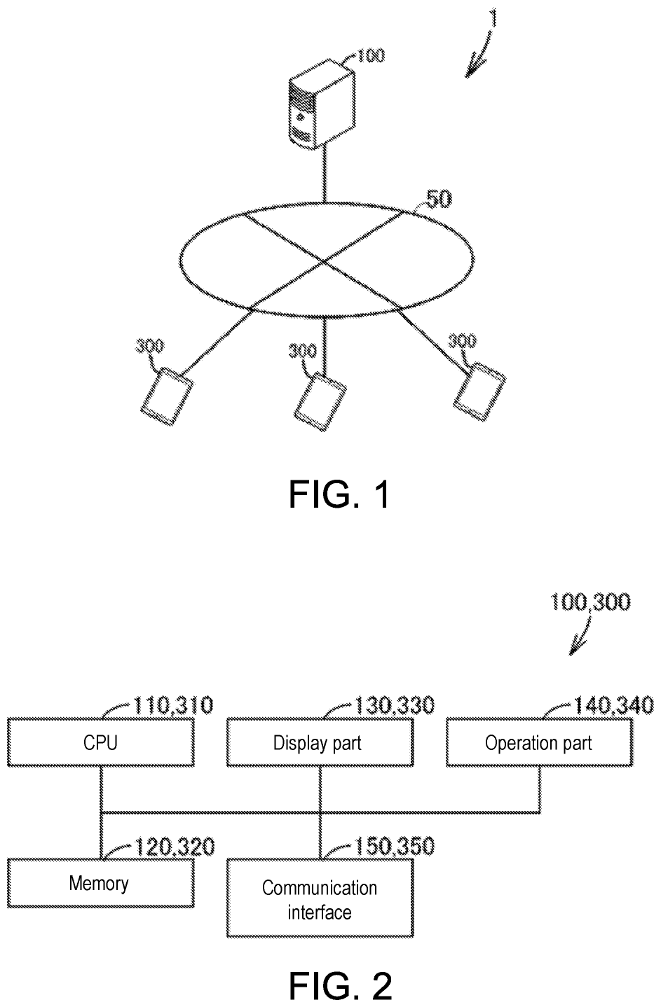

As shown in FIG. 1, a consumable material map generation system 1 according to an embodiment of the invention is mainly formed by a server 100 and multiple consumer terminals 300. In the following, the forming elements are respectively described in detail. As shown in FIG. 1, these forming elements are connected to be able to communicate with each other via a communication network 50. The communication network 50 may be configured by any kind of communication network (e.g., the Internet, a carrier network, etc.), regardless of whether such network is a wired network or a wireless network.

1⋅Server

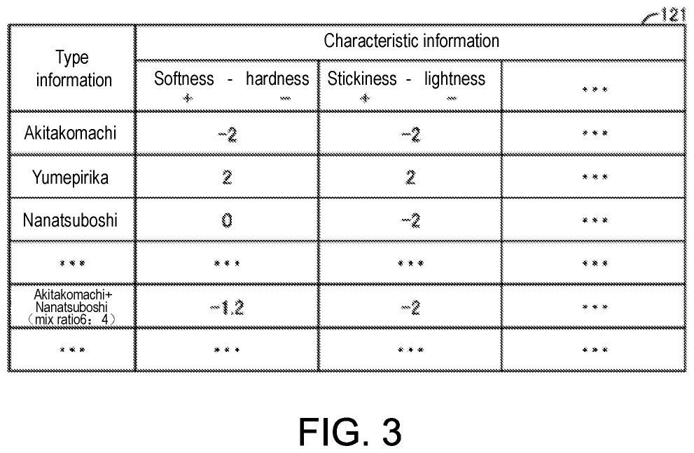

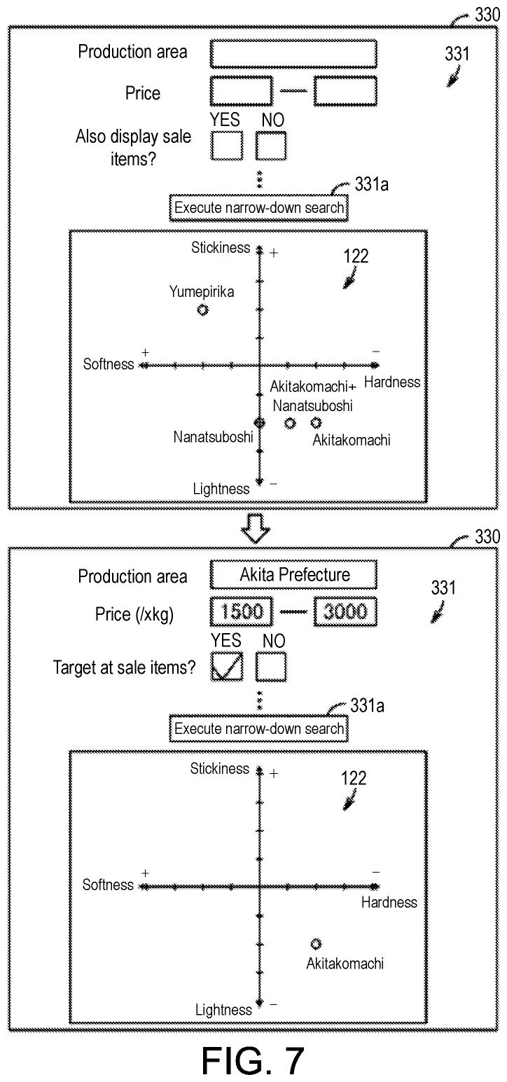

Firstly, the configuration of the server 100 is described. The server 100 keeps a table 121 (see FIG. 3) for a consumable material map in which at least one characteristic information is associated with type information of consumable materials and a consumable material association information table 123 (see FIG. 7) in which at least one consumable material association information is associated with the type information of the consumable materials, generates consumable material map information 122 based on the table 121 for the consumable material map, for example, displays the consumable material map information 122 on a consumer terminal 300 via the communication network 50, and registers input information transmitted from the consumer terminal 300 to the table 121 for the consumable material map and the consumable material association information table 123. As shown in FIG. 2, the server 100 is mainly formed by a central processing unit (CPU) 110, a memory 120, a display part 130, an operation part 140, and a communication interface 150, etc. In the following, the forming elements are respectively described in detail.

(1) CPU

The CPU 110 executes a program stored in the memory 120, thereby controlling the respective parts of the sever 100, and acquiring necessary data from the memory 120 to perform a computing process (e.g., an arithmetic process, a logical process, etc.). For example, the CPU 110 executes the program stored in the memory 120, and executes various processes described in the following by referring to various data.

(2) Memory

The memory 120 may be various random access memories (RAMs), various read-only memories (ROMs), etc., may be contained in the sever 100, may also be attachable/detachable to various interfaces of the server 100, and may also be a storage medium of another device (e.g., a data management server not shown herein) accessible from the server 100. The memory 120 stores the program executed by the CPU 110, data generated through executing the program by the CPU 110, data input via the operation part 140, data received from the consumer terminal 300, etc., via the communication network 50, the table 121 for the consumable material map, the consumable material map information 122, and the consumable material association information table 123, etc.

In the table 121 for the consumable material map, as shown in FIG. 3, characteristic information (e.g., value information in indices such as “softness-hardness” or “stickiness-lightness”) is associated with type information (e.g., “Akitakomachi”, “Yumepirika”, “Nanatsuboshi”, etc.) of consumable materials (e.g., rice, etc.). For example, referring to FIG. 3, “−2” in the index of “softness-hardness” and “−2” in the index of “stickiness-lightness” are associated with “Akitakomachi”. Therefore, it is known that “Akitakomachi” has the characteristic that tends to be “hard” and “light”. In the consumable material map generation system 1 according to the embodiment of the invention, each characteristic information is shown by using value information in a range of “−4” to “4”.

The type information of the consumable material and the characteristic information corresponding to the type information of the consumable material can be newly registered to the table 121 for the consumable material map. In such case, the CPU 110 newly registers the type information of the consumable material and the characteristic information corresponding to the type information of the consumable material to the table 121 for the consumable material map based on the input from the manager of the server 100. In addition, it is also possible that a CPU 310 (to be described afterwards) of the consumer terminal 300 receives the input of the type information of the consumable material and the characteristic information corresponding to the type information of the consumable material from the user of the consumer terminal 300, transmits such information to the server 100 via the communication network 50, and registers such information to the table 121 for the consumable material map with respect to the server 100.

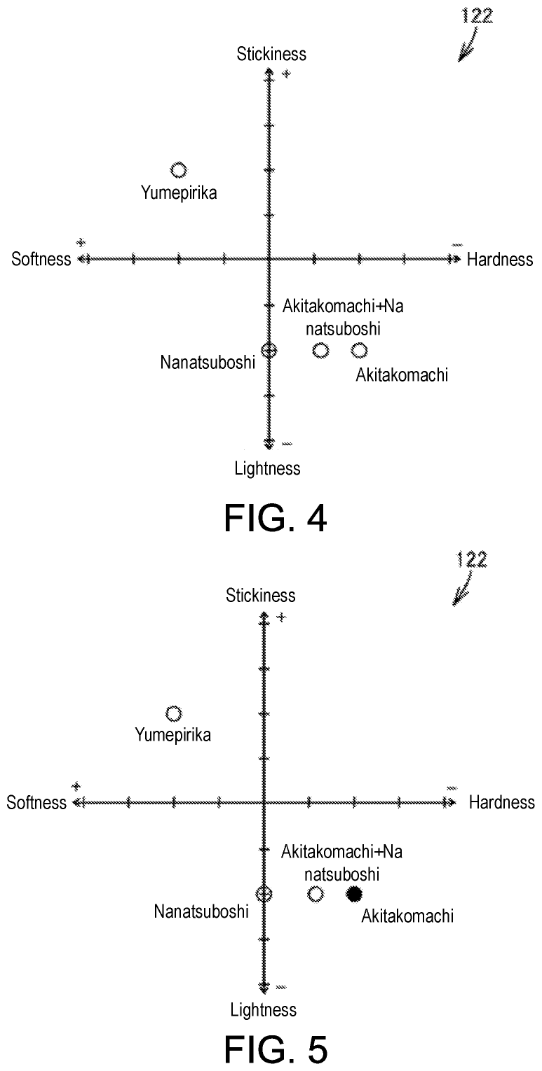

In addition, as shown in FIG. 3, the type information of the consumable materials includes the type information of a mixed consumable material obtained by mixing at least two types of consumable materials (e.g., “Akitakomachi”+“Nanatsuboshi”). Mixed characteristic information is associated with the type information of such mixed consumable material. The mixed characteristic information is determined based on the characteristic information corresponding to the type information of the consumable materials forming the mixed consumable material and the mixed ratio information of these types of consumable materials. For example, referring to FIG. 4, “−1.2” in the index of “softness-hardness” and “−2” in the index of “stickiness-lightness” are associated with “Akitakomachi”+“Nanatsuboshi”. More specifically, “−1.2” in the index of “softness-hardness” is obtained by using a formula “−2×0.6+0×0.4”, and “−2” in the index of “stickiness-lightness” is obtained by using a formula “−2×0.6+(−2)×0.4”. That is, the mixed characteristic information in each index is obtained by using a sum of “the characteristic information corresponding to the type information of each consumable material”×“the mix ratio of the respective consumable materials”.

Regarding the characteristic information newly registered to the table 121 for the consumable material map, such as the mixed characteristic information obtained from the formula, the value information thereof may also be suitably modified by inputting value information from the CPU 110 of the server 100 and the CPU 310 of the consumer terminal 300. For example, with respect to “−1.2” of the mixed characteristic information in the index of “softness-hardness” of “Akitakomachi” and “Nanatsuboshi” described above, by inputting the value information “−2”, the mixed characteristic information in the index of “softness-hardness” may also be changed to “−2”.

In the consumable material map information 122, as shown in FIG. 4, the type information of the consumable material (e.g., “Akitakomachi”, “Yumepirika”, “Nanatsuboshi”) is mapped two-dimensionally based on the table 121 for the consumable material map. In FIG. 4, the index of “softness-hardness” is set to X-axis, and the index of “stickiness-lightness” is set to Y-axis.

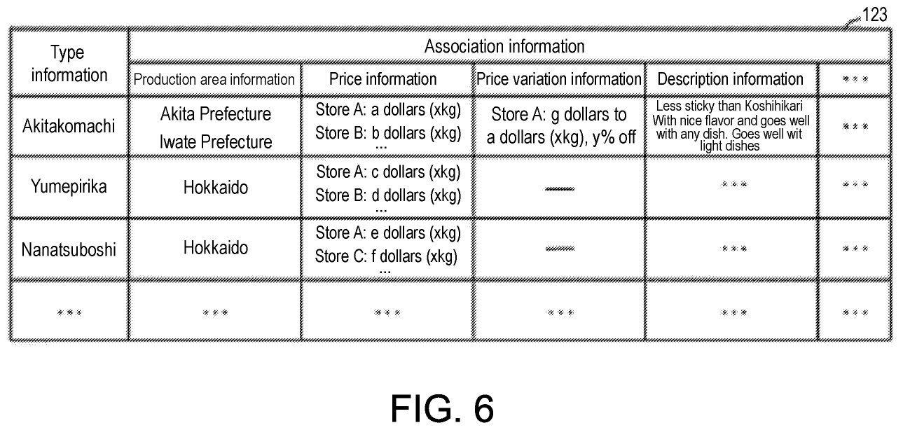

In the consumable material association information table 123, as shown in FIG. 6, the association information (e.g., production area information, price information, price variation information, and description information, etc.) is associated with the type information (e.g., “Akitakomachi”, “Yumepirika”, “Nanatsuboshi”, etc.) of the consumable materials (e.g., rice, etc.). The production area information is the information indicating the production area corresponding to the type information of the consumable materials. The price information is the information indicating the prices corresponding to the type information of the consumable materials in respective stores. The price variation information is the information indicating the price variations corresponding to the type information of the consumable materials in respective stores. The description information is the information indicating the characteristics concerning the type information of the consumable materials. For example, with reference to FIG. 7, for “Akitakomachi”, it is shown that the production area is “Akita prefecture” and “Iwate prefecture”, the price at Store A is a dollars per xkg, and the price is after a y % discount.

(3) Display Part

The display part 130 displays text, images, video, etc., based on signals from the CPU 110. For example, the display part 130 displays the table 121 for the consumable material map (see FIG. 3), the consumable material map information 122 (see FIG. 4), and the consumable material association information table 123 (see FIG. 6). The display part 130 may also be provided with a touch panel function.

(4) Operation Part

The operation part 140 is a mouse, a keyboard, a button, a touch panel, etc., and inputs various commands from the manager of the server 100, etc., into the CPU 110.

(5) Communication Interface

The communication interface 150 transmits data (e.g., the consumable material map information 122, etc.) from the CPU 110 to another device, such as the consumer terminal 300, via the communication network 50, whereas the communication interface 150 also receives the data from the consumer terminal 300 via the communication network 50 and transmits the data to the CPU 110.

2⋅Consumer Terminal

In the following, the configuration of the consumer terminal 300 is described. The consumer terminal 300 is used by the consumer, etc., of the consumable materials, and is realized by a personal computer, a tablet terminal, or a smart phone, etc. The consumer terminal 300 can display the consumable material map information 122 stored in the memory 120 of the server 100 on a display part 330 via the communication network 50. As shown in FIG. 2, the consumer terminal 300 is mainly formed by the CPU 310, a memory 320, the display part 330, an operation part 340, and a communication interface 350, etc. In the following, the forming elements are described in detail.

(1) CPU

The CPU 310 executes a program stored in the memory 320, thereby controlling the respective parts of the consumer terminal 300, and acquiring necessary data from the memory 320 to perform a computing process (e.g., an arithmetic process, a logical process, etc.). For example, the CPU 310 executes the program stored in the memory 320, and executes various processes described in the following by referring to various data.

(2) Memory

The memory 320 may be various RAMs, various ROMs, etc. The memory 320 stores the program executed by the CPU 310, data generated through executing the program by the CPU 310, data input via the operation part 340, and data (e.g., the consumable material map information 122) received from the server 100, etc., via the communication network 50.

(3) Display Part

The display part 330 displays text, images, a video, etc., based on signal from the CPU 310. For example, the display part 300 displays a narrow-down page 331 (to be described afterwards) for the consumable material map information 122 (see FIGS. 4 and 5), a selection page 332 (to be described afterwards), and a target type information setting page 333 (to be described afterwards). etc. The display part 330 may also be provided with a touch panel function.

(4) Operation Part

The operation part 340 is a mouse, a keyboard, a button, a touch panel, etc., and inputs various commands from the user of the consumer terminal 300, etc., into the CPU 310.

(5) Communication Interface

The communication interface 350 transmits data from the CPU 310 to another device, such as the server 100, via the communication network 50, whereas the communication interface 350 also receives data (e.g., the consumable material map information 122, etc.) from another device, such as the server 100, via the communication network 50, and transmits the data to the CPU 310.

<Method of Using Consumer Terminal and Outline of Information Processing of Consumable Material Map Generation System According to the Embodiment of the Invention>

In the consumable material map generation system 1 according to the embodiment of the invention, by using the consumer terminal 300, the user of the consumer terminal 300 can change the display configuration of the type information on the consumable material map information 122, narrow down the type information on the consumable material map information 122, obtain information associated with various type information on the consumable material map information 122, select the type information displayed on the consumable material map information 122, and obtain the type information corresponding to the characteristic information sandwiched between the characteristic information corresponding to the selected type information and the favorite characteristic information. In the following, a method of using the consumable material map information system 1 and the outline of information processing according to the embodiment of the invention are described.

The user of the consumer terminal 300 can, via the operation part 340, input the type information of the consumable material possessed by him/herself, and freely select symbol information (e.g., a symbol “0”, etc.) corresponding to the type information on the consumable material map information 122 displayed on the display part 330.

Then, in the consumable material map information 122 stored in the memory 120 of the server 100, the CPU 310 can display with emphasis the symbol information corresponding to the type information input (selected) by the user of the consumer terminal 300. For example, when the user of the consumer terminal 300 inputs (selects) “Akitakomachi” via the operation part 340, as shown in FIG. 5, the CPU 310 displays with emphasis, by using a black circle, the symbol information corresponding to “Akitakomachi” on the consumable material map information 122.

In addition, as shown in FIG. 7, the user of the consumer terminal 300 can, via the operation part 340, input information to items (e.g., a consumable material production area item, a price range item, an item targeting at sale items, etc.) in the narrow-down page 331 displayed on the display part 330. As shown in FIG. 7, when information is input to each item, the CPU 310 displays on the consumable material map information 122 only the type information of the consumable material corresponding to the input information based on the consumable material association information table 123 stored in the memory 120 of the server 100. For example, in FIG. 7, the user of the consumer terminal 300, via the operation part 340, inputs “Akita Prefecture” to the production area item, inputs “1500 dollars to 3000 dollars” to the price range item, and checks the item targeting at sale items. Then, when the user of the consumer terminal 300 selects a narrow-down search execution button 331a via the operation part 340, the CPU 310 displays only “Akitakomachi” corresponding to the input information on the consumable material map information 122 based on the consumable material association information table 123.

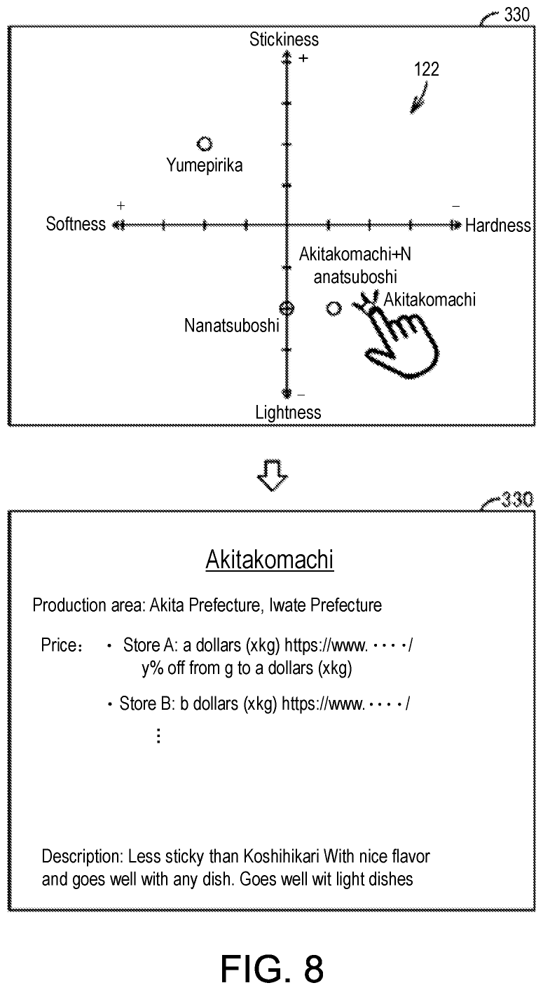

In addition, as shown in FIG. 8, the user of the consumer terminal 300 can obtain information in association with each type information on the consumable material map information 122 displayed on the display part 330. Firstly, as shown in FIG. 8, the user of the consumer terminal 300 selects the type information on the consumable material map information 122 displayed on the display part 330 via the operation part 340. It is noted that the selection described herein may be distinguished from the selection for displaying with emphasis the symbol information corresponding to the type information on the consumable material map information 122 described above. For example, the selection described herein may be a selection of long-pressing or continuous selections (double-click, double-tap, etc.) of the type information on the consumable material map information 122. Then, when the type information on the consumable material map information 122 is selected, the information in association with the selected type information is displayed on the display part 330 based on the consumable material association information table 123. For example, in FIG. 8, the user of the consumer terminal 300 selects “Akitakomachi” on the consumable material map information 122 via the operation part 340. Then, based on the consumable material association information table 123, the CPU 310 displays the association information (e.g., production area information, price information, price variation information, description information, etc.) of “Akitakomachi” on the display part 330 (see FIG. 8). In the case where a store included in the price information is a store compatible with on-line purchase, as shown in FIG. 8, the URL information of the on-line purchase site of the store is also displayed on the display part 330. Accordingly, the user of the consumer terminal 300 can open the on-line purchase site linked to the URL information via the operation part 340.

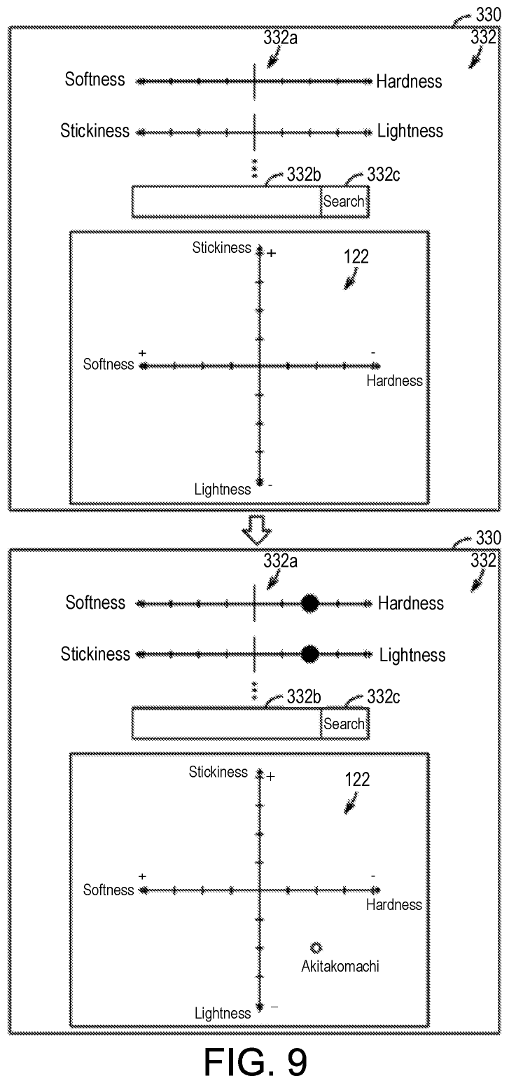

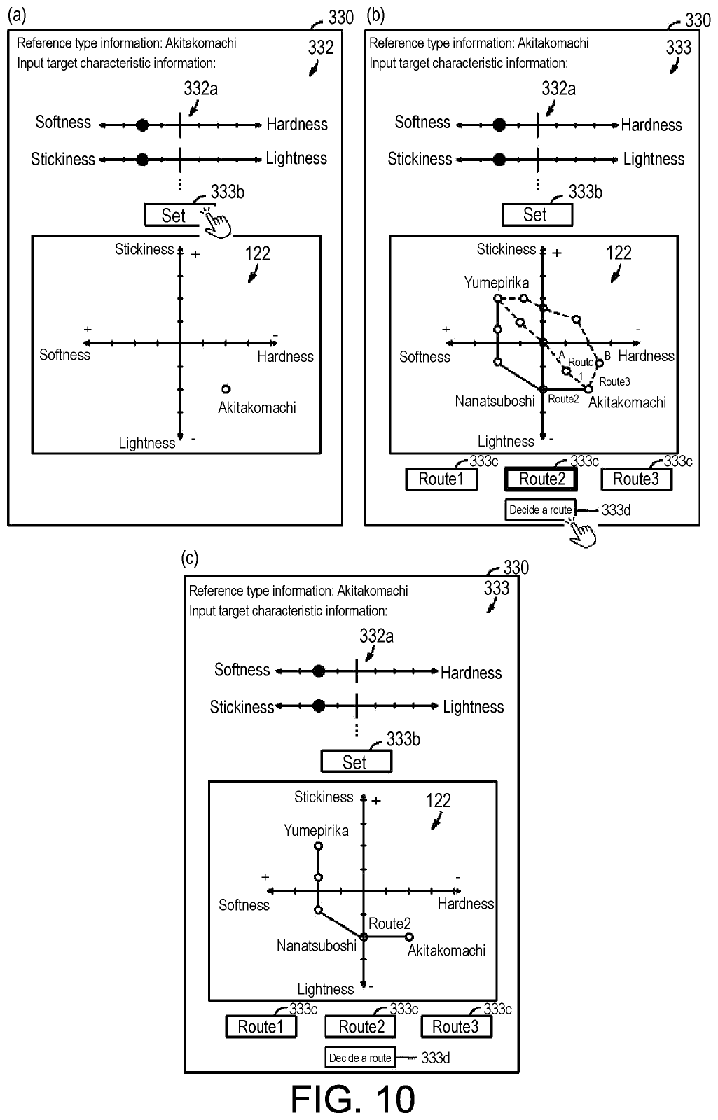

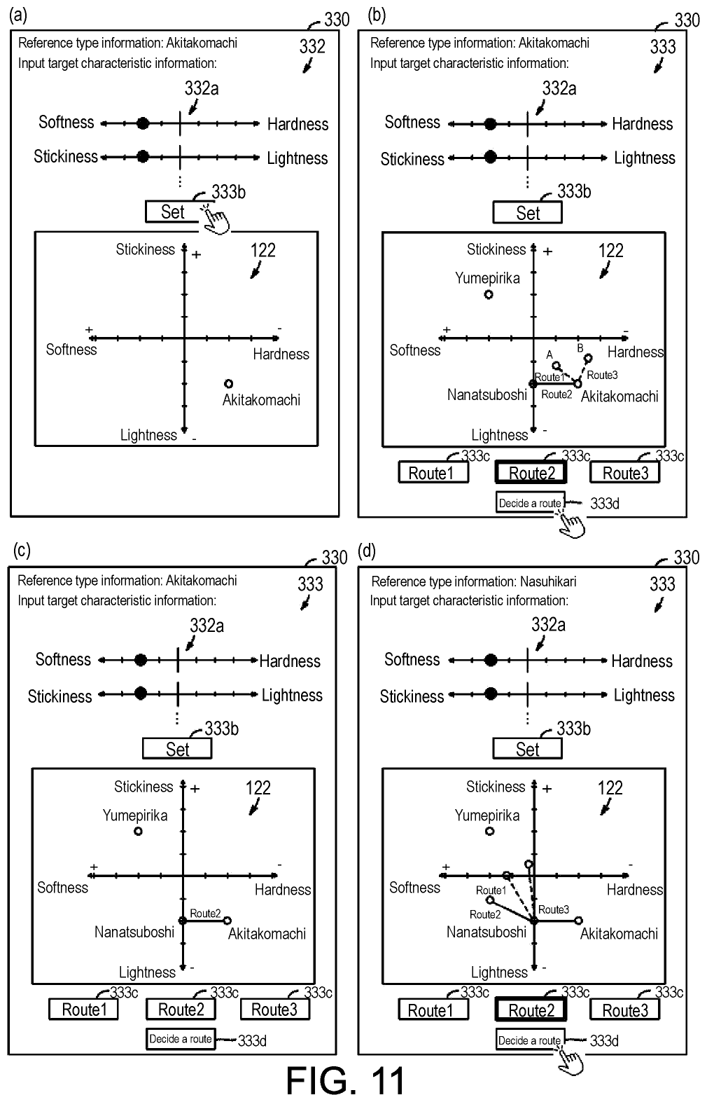

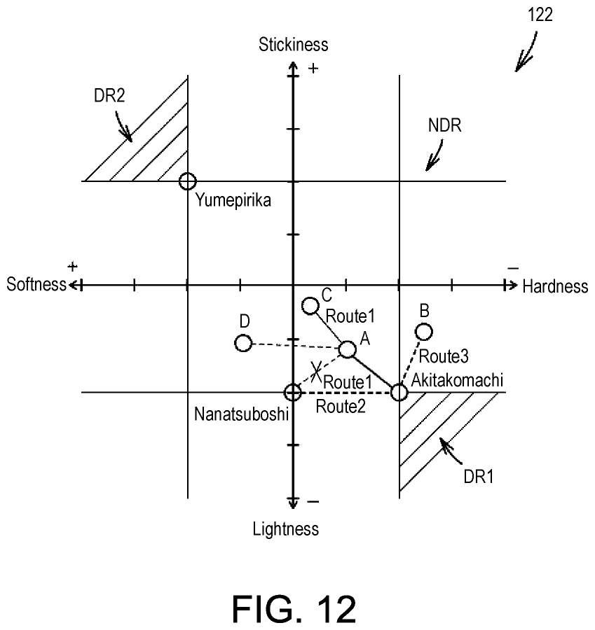

In addition, as shown in FIG. 9, the user of the consumer terminal 300 can select the type information displayed on the consumable material map information 122 via the operation part 340. As shown in FIG. 9, the selection page 332 is displayed on the display part 330, and includes the consumable material map information 122, a characteristic information slide bar 332a, a search window 332b, and a search execution button 332c, etc. As shown in FIG. 9, the CPU 310 receives an operation of the characteristic information slide bar 332a made via the operation part 340 from the user of the consumer terminal 300. Then, the CPU 310 matches the value information of the characteristic information slide bar 332a with the characteristic information of the table 121 for the consumable material map stored in the memory 120 of the server 100, and, based on the table 121 for the consumable material map, displays the type information corresponding to the characteristic information consistent with (or similar to) the value information on the consumable material map information 122. For example, in FIG. 9, the value information of the bar of the characteristic information slide bar 332a is “−2” in the index of “softness-hardness” and “−2” in the index of “stickiness-lightness”. Then, the CPU 310 displays “Akitakomachi” corresponding to the characteristic information consistent with the value information on the consumable material map information 122. Alternatively, the CPU 310 displays the type information corresponding to the characteristic information similar to the value information on the consumable material map information 122. It is noted that the type information corresponding to the characteristic information similar to the value information is, for example, one whose distance is closest from the coordinates when the value information is plotted on the consumable material map information 122. In addition, the user of the consumer terminal 300 inputs the type information to the search window 332b via the operation part 340 to select the search execution button 332c. Then, the CPU 310 matches the input type information with the table 121 for the consumable material map stored in the memory 120 of the server 100. When succeeding in matching, the CPU 310 plots the characteristic information corresponding to the input type information on the consumable material map information 122, and displays the input type information on the consumable material map information 122.

In addition, as shown in (a) to (c) of FIG. 10, the user of the consumer terminal 300 can obtain a route (passage) to from the reference type information to target type information through type information other than the reference type information and the target type information by setting one type information as the reference type information and one type information as the target type information. Here, the reference type information is, for example, the type information (e.g., “Akitakomachi”) of the consumable material currently possessed or consumed by the user of the consumer terminal 300, and the target type information is, for example, the type information (e.g., “Yumepirika”) corresponding to the target characteristic information ideal to the user of the consumer terminal 300. As shown in (a) to (c) FIG. 10, the target type information setting page 333 is displayed on the display part 330 and includes the consumable material map information 122, the characteristic information slide bar 332a, a setting button 333b, a route selection button 333c, and a route determining button 333d. Firstly, as shown in (a) of FIG. 10, the CPU 310 sets one type information (e.g., “Akitakomachi”) as the reference type information based on the selection (input) from the user of the consumer terminal 300 via the operation part 340. Then, as shown in (a) of FIG. 10, the CPU 310 receives the operation of the characteristic information slide bar 332a (that is, the input of the target characteristic information) and the selection of the setting button 333b from the user of the consumer terminal 300 via the operation part 340. For example, in (a) of FIG. 10, in the target characteristic information, “2” is set in the index of “softness-hardness” and “2” is set in the index of “stickiness-lightness”. Then, as shown in (b) of FIG. 10, the CPU 310 displays the type information from the reference type information to the target type information through the type information other than the reference type information and the target type information for each route on the consumable material map information 122. The method for deriving each route will be described in the following.

It is noted that, in (b) of FIG. 10, at the time point when the user of the consumer terminal 300 selects the setting button 333b, all the type information from the reference type information to the target type information is displayed in series for each route. In addition, in the case where the target type information fully corresponding to the target characteristic information is not stored in the table 121 for the consumable material map, the type information corresponding to the characteristic information whose distance is closest from the coordinates when the target characteristic information is plotted on the consumable material map information 122 is displayed as the target type information on the consumable material map information 122. Then, as shown in (b) of FIG. 10, the CPU 310 receives the selection of any one (e.g., a button for a route 2) of the route selection buttons 333c and the selection of the route determining button 333d from the user of the consumer terminal 300 via the operation part 340. As shown in (b) of FIG. 10, when one of the route selection buttons 333c is selected, the CPU 310 displays the passage of the route (e.g., the route 2) corresponding to the route selection button 333c that is selected in a solid line, and displays the passages of routes (e.g., routes 1 and 3) corresponding to the route selection buttons 333c not selected in a manner (e.g., displaying in dotted lines) other than displaying in a solid line. Then, when the route determining button 333d is selected, as shown in (c) of FIG. 10, the CPU 310 displays only the route selected by the user of the consumer terminal 300 on the consumable material map information 122.

It is noted that, in (b) of FIG. 10, as described above, at the time point when the user of the consumer terminal 300 selects the setting button 333b, all the type information from the reference type information to the target type information is displayed in series for each route. However, as shown in (a) to (b) of FIG. 11, at the time point when the user of the consumer terminal 300 selects the setting button 333b, the CPU 310 can display only the next type information from the reference type information to the target type information for each route. Then, as shown in (b) of FIG. 11, the CPU 310 receives the selection of any one (e.g., the button for the route 2) of the route selection buttons 333c and the selection of the route determining button 333d from the user of the consumer terminal 300 via the operation part 340. As shown in (b) of FIG. 11, when one of the route selection buttons 333c is selected, the CPU 310 displays the passage of the route (e.g., the route 2) corresponding to the route selection button 333c that is selected in a solid line, and displays the passages of the routes (e.g., the routes 1 and 3) corresponding to the route selection buttons 333c that are not selected in a manner (e.g., dotted lines) other than displaying in a solid line. Then, when the route determining button 333d is selected, as shown in (c) of FIG. 11, the CPU 310 displays only the route selected by the user of the consumer terminal 300 on the consumable material map information 122. Then, as shown in (d) of FIG. 11, the CPU 310 sets the next type information (e.g., “Nanatsuboshi”) displayed on the route selected by the user of the consumer terminal 300 as new reference type information. Then, as shown in (d) of FIG. 11, the CPU 310 displays the type information from the new reference type information to the target type information through the type information other than the reference type information and the target type information for each route on the consumable material map information 122 based on the table 121 for the consumable material map. At this time as well, the CPU 310 displays only the next type information from the new reference type information to the target type information for each route. The CPU 310 repeats the process until the target type information is set as the new reference type information.

Here, the method for deriving each route in (a) to (c) of FIG. 10 and (a) to (d) of FIG. 11 is described. When the reference type information and the target type information are set, the CPU 310 derives a first diagonal range DR1 and a second diagonal range DR2 shown in FIG. 12. The first diagonal range DR1 is “the range of a side where all the respective index values of the characteristic information corresponding to the reference type information are away from the respective index values of the characteristic information corresponding to the target type information” on the consumable material map information 122. The second diagonal range DR2 is “the range of a side where all the respective index values of the characteristic information corresponding to the target type information are away from the respective index values of the characteristic information corresponding to the reference type information” on the consumable material map information 122. By setting the reference type information as “Akitakomachi” and setting the target type information as “Yumepikari”, the first diagonal range DR1 and the second diagonal range DR2 are described in detail with reference to FIG. 12. The first diagonal range DR1 is a range of a side where both the index value “−2” of “softness-hardness” and the index value “−2” of “stickiness-softness” of “Akitakomachi” are away from the index value “2” of “softness-hardness” and “2” of “stickiness-lightness” of “Yumepirika”, that is, the index of “softness-hardness” is “equal to or less than −2” and the index of “stickiness-lightness” is “equal to or less than −2”. The second diagonal range DR2 is a range of a side where both the index value “2” of “softness-hardness” and the index value “2” of “stickiness-softness” of “Yumepirika” are away from the index value “−2” of “softness-hardness” and “−2” of “stickiness-lightness” of “Akitakomachi”, that is, the index of “softness-hardness” is “equal to or more than 2” and the index of “stickiness-lightness” is “equal to or more than 2”. Then, when the first diagonal range DR1 and the second diagonal range DR2 are derived, the CPU 310 derives each route for the type information present in a non-diagonal range NDR excluding the first diagonal range DR1 and the second diagonal range DR2 as target. Firstly, as shown in (a) to (d) of FIG. 11 and FIGS. 12, the CPU 310 derives the route 1. The route 1 is a route constantly the shortest from the reference type information to the target type information. In (a) to (d) of FIG. 11 and FIGS. 12, the route 1 contains type information “A”. Then, the CPU 310 derives each route, except for the route 1, for the type information present in a range on two sides (but within the non-diagonal range NDR) with the route 1 as the axis and the type information that is closest from the reference type information within the range on the two sides. In FIG. 12, the range on the two sides with the route 1 as the axis is an upper side range or a lower side range with respect to a virtual line extending from the reference type information “Akitakomachi” to the type information “A” on the route 1. In FIG. 12, a route 3 is derived in the upper side range with the route 1 as the axis, and includes type information “B” with the shortest distance from the reference type information “Akitakomachi”. Also, a route 2 is derived in the lower side range with the route 1 as the axis, and includes type information “Nanatsuboshi” with the shortest distance from the reference type information “Akitakomachi”. While not shown in the drawing, in the case where no type information is present in a single-side range within the range on the two sides with the route 1 as the axis, no route is derived in such single-side range. While not shown in the drawing, in the case where multiple type information with the shortest distance from the reference type information are present in a single-side range within the range on the two sides with the route 1 as the axis, multiple routes are derived from the single-side range. Then, as shown in FIG. 12, the following case is described: the route 1 from the reference type information “Akitakomachi” to the type information “A” is selected, the new route 1 from the new reference type information “A” to type information “C” is derived, and in the lower side range with the new route 1 as the axis, “Nanatsuboshi” once displayed as the type information of the route destination is present as the one with the shortest distance from the reference type information “A”. According to the route derivation method, in the lower side range with the new route 1 as the axis, “Nanatsuboshi” is present as the one with the shortest distance from the reference type information “A”. Therefore, a route from the reference type information “A” to “Nanatsuboshi” should be derived. However, even if “Nanatsuboshi” has the shortest distance from the reference type information “A”, the CPU 310 does not derive the route from the new reference type information “A” to “Nanatsuboshi” which is once displayed as the route destination. Instead, in the lower side range with the new route 1 as the axis, the CPU 310 derives a route targeting at type information “D” with the shortest distance from the new reference type information “A” among the type information other than “Nanatsuboshi” that is once displayed as the route destination.

<Characteristics of Consumable Material Map Generation System According to the Embodiment of the Invention>

(1)

In the consumable material map generation system 1 according to the embodiment of the invention, based on the table 121 for the consumable material map, the consumable material map information 122 in which the type information of the consumable materials is mapped two-dimensionally is generated. Then, the consumable material map information 122 is displayed on the display part 130 of the server 100 or the display part 330 of the consumer terminal 300. Therefore, in the consumable material map generation system 1, a favorite type of consumable materials can be found efficiently.

(2)

In the consumable material map generation system 1 according to the embodiment of the invention, the CPU 310 of the consumer terminal 300 can display with emphasis the symbol information corresponding to the type information input (selected) by the user of the consumer terminal 300 via the operation part 340 on the consumable material map information 122. In such consumable material map generation system 1, the type information input (selected) by the user of the consumer terminal 300 and the type information not input (selected) can be clearly distinguished.

(3)

In the consumable material map generation system 1 according to the embodiment of the invention, the type information in the table 121 for the consumable material map includes the type information of the mixed consumable material obtained by mixing at least two types of consumable materials. Then, the mixed characteristic information determined based on the characteristic information corresponding to the type information of the consumable materials forming the mixed consumable material and the mix ratio information of the types of consumable materials is associated with the type information of such mixed consumable material. Therefore, in the consumable material map generation system 1, the fun and the value of mixing various types of consumable materials can be provided.

(4)

In the consumable material map generation system 1 according to the embodiment of the invention, the CPU 310 of the consumer terminal 300 can receive the reference type information and the target type information from the user of the consumer terminal 300 via the operation part 340. Then, the CPU 310 of the consumer terminal 300 displays the route from the reference type information to the target type information through the type information other than the reference type information and the target type information on the display part 330 of the consumer terminal 300. Therefore, in the consumable material map generation system 1, the consumer can enjoy and search for various types of consumable materials by targeting at the type of consumable materials with the favorite characteristic.

(5)

In the consumable material map generation system 1 according to the embodiment of the invention, the CPU 310 of the consumer terminal 300 can receive the information input to the items in the narrow-down page 331 from the user of the consumer terminal 300 via the operation part 340. Then, based on the consumable material association information table 123, the CPU 310 of the consumer terminal 300 can display only the type information of the consumable material corresponding to the input information on the consumable material map information 122. Therefore, in the consumable material map generation system 1, a favorite type of consumable materials can be found efficiently.

(6)

In the consumable material map generation system 1 according to the embodiment of the invention, the CPU 310 of the consumer terminal 300 can display the information associated with the type information selected by the user of the consumer terminal 300 based on the consumable material association information table 123. Therefore, in the consumable material map generation system 1, the consumer can simply learn the information in association with the selected type information.

(7)

In the consumable material map generation system 1 according to the embodiment of the invention, the CPU 310 of the consumer terminal 300 can receive the operation of the characteristic information slide bar 332a from the user of the consumer terminal 300 via the operation part 340. Then, the CPU 310 of the consumer terminal 300 can match the value information of the characteristic information slide bar 332a with the characteristic information of the table 121 for the consumable material map, and, based on the table 121 for the consumable material map, display the type information corresponding to the characteristic information consistent with (or similar to) the value information on the consumable material map information 122. In addition, the CPU 310 of the consumer terminal 300 can receive the input of the type information from the user of the consumer terminal 300 to the search window 332b via the operation part 340. Then, the CPU 310 of the consumer terminal 300 can match the input type information with the table 121 for the consumable material map and, based on the table 121 for the consumable material map, display the input type information on the consumable material map information 122. Therefore, in the consumable material map generation system 1, the user can easily have a grasp on the type information and the characteristic information of the consumable material serving as a purchase candidate for the next time.

### Modified Example

(A)

In the consumable material map information 122 of the consumable material map generation system 1 according to the embodiment, the type information of the consumable material is mapped two-dimensionally by using the index “softness-hardness” and the index “stickiness-lightness” as the axes. However, the indexes are not limited to “softness-hardness” and “stickiness-lightness”. For example, an index such as “sweetness-bitterness” may also be adopted. In addition, in the consumable material map information 122, the type information of the consumable material may also be mapped one-dimensionally by using one index as the axis, and may also be mapped three or more dimensionally by using three or more indexes as the axes. In addition, in the consumable material map information 122, the type information of the consumable material may also be expressed through a bubble chart or a heat map based on the table 121 for the consumable material map.

(B)

In the consumable material map generation system 1 according to the embodiment, the CPU 310 of the consumer terminal 300 can display with emphasis the symbol information corresponding to the type information input (selected) by the user of the consumer terminal 300 in the consumable material map information 122 by using a black circle. However, the CPU 310 of the consumer terminal 300 may also display, with emphasis, the symbol information corresponding to the type information in the consumable material map information 122 in a manner (e.g., blinking, color-changing, etc.,) other than using a black circle. Alternatively, the CPU 310 of the consumer terminal 300 may also display with emphasis the type information in the consumable material map information 122 by changing the manner of displaying such type information (e.g., blinking, color-changing, using a bold font, using an italic font, changing the font, etc.).

(C)

While not described in the consumable material map generation system 1 according to the embodiment, the CPU 310 of the consumer terminal 300 may also display at least one, for each route, of the type information from the reference type information to the target type information through the type information other than the reference type information and the target type information on the consumable material map information 122 based on the table 121 for the consumable material map.

(D)

While not described in the consumable material map generation system 1 according to the embodiment, the consumer terminal 300 may also be a consumable material processing device 200 of a rice cooker, a coffee machine or a rotation device such as a juicer or a food processor. In such case, a computer with a display part having a communication interface able to be connected with the communication network 50, for example, is mounted in the consumable material processing device 200, and the same function as the consumer terminal 300 is mounted.

(E)

A portion or the entirety of the function of each device such as the server 100 or the consumer terminal 300 of the consumable material map generation system 1 according to the embodiment may also be executed by another device. For example, the consumer terminal 300 may also keep the table 121 for the consumable material map, generate the consumable material map information 122 from the table 121 for the consumable material map received from the server 100 or from the table 121 for the consumable material map kept by itself, and generate the consumable material association information table 123.

The modified examples may be applied individually to each example, or may be applied in combination of a plurality of examples.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A consumable material map generation system, comprising:
a storage part, associating at least one characteristic information with respect to type information of consumable materials and storing the characteristic information;
an information display part, displaying information; and
an information processing part, generating a consumable material map by mapping the type information one or more dimensionally based on the characteristic information to display the consumable material map on the information display part.

2. The consumable material map generation system as claimed in claim 1, wherein the information processing part is capable of displaying, with emphasis, at least one type information selected among the mapped type information on the consumable material map.

3. The consumable material map generation system as claimed in claim 1, having a first setting function in which one type information among the type information is set as reference type information and a second setting function in which one type information among the type information is set as target type information,
wherein, in a case where the reference type information is set by the first setting function and the target type information is set by the second setting function, the information processing part connects, by using a line, the type information so that a distance of a passage from the reference type information to the target type information through the type information other than the reference type information and the target type information is shortest and displays the type information on the information display part.

4. The consumable material map generation system as claimed in claim 1, wherein the type information comprises information of a mixed consumable material obtained by mixing at least two types of the consumable materials, and
the characteristic information comprises mixed characteristic information determined based on the characteristic information corresponding to the type information of the consumable materials forming the mixed consumable material and information of a mix ratio of the consumable materials.

5. The consumable material map generation system as claimed in claim 2, having a first setting function in which one type information among the type information is set as reference type information and a second setting function in which one type information among the type information is set as target type information,
wherein, in a case where the reference type information is set by the first setting function and the target type information is set by the second setting function, the information processing part connects, by using a line, the type information so that a distance of a passage from the reference type information to the target type information through the type information other than the reference type information and the target type information is shortest and displays the type information on the information display part.

6. The consumable material map generation system as claimed in claim 2, wherein the type information comprises information of a mixed consumable material obtained by mixing at least two types of the consumable materials, and
the characteristic information comprises mixed characteristic information determined based on the characteristic information corresponding to the type information of the consumable materials forming the mixed consumable material and information of a mix ratio of the consumable materials.

7. The consumable material map generation system as claimed in claim 3, wherein the type information comprises information of a mixed consumable material obtained by mixing at least two types of the consumable materials, and
the characteristic information comprises mixed characteristic information determined based on the characteristic information corresponding to the type information of the consumable materials forming the mixed consumable material and information of a mix ratio of the consumable materials.
